(19) United States
(12) Patent Application Publication
(10) Pub. No.: US 2007/0122024 A1
(43) Pub. Date: May 31, 2007

(54) Method for processing checks prior to electronic deposit

(75) Inventors: Bertrand Haas, New Haven, CT (US); Matthew J. Campagna, Ridgefield, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/289,255

(22) Filed: Nov. 29, 2005

(51) Int. Cl. G06K 9/00

(52) U.S. Cl. 382/137

(57) ABSTRACT

A method of processing a check prior to submitting it for deposit in which the depositor's intent at the time of submitting the check is linked with an image of the check. The method includes receiving from the depositor intended amount information for the check, generating a first image of a front of the check, and generating an image of the intended amount. The method further includes generating a second image of the front of the check using the first image of the front of the check, wherein the second image of the front of the check includes the image of the intended amount and wherein the first image of the front of the check may be obtained from the second image of the front of the check. Finally, the method includes submitting at least the second image of the front of the check to a depository bank.

### FIELD OF THE INVENTION

The present invention relates to check deposit systems, and in particular to a method for processing checks prior to electronic deposit including linking information relating to the intent of the depositor with an image of a corresponding check.

### BACKGROUND OF THE INVENTION

Traditionally, businesses have deposited checks received from, for example, customers by physically taking them to a branch of their bank and depositing them over the counter with a teller or dropping them into a night deposit box. The actual physical presentation of checks to be deposited was necessary because, under prior banking laws, the depository bank had to present the original of each check to the corresponding paying bank in order to clear the check. This changed in October of 2004 with the enactment of The Check Clearing for the 21^{st} Century Act, commonly referred to Check 21. Check 21 removed the legal requirement that an original paper check had to be presented to obtain payment. Instead, banks can now use digital images to transport check data from the bank of first deposit to the paying bank. If the paying bank cannot process a check image, the image can be printed, according to certain specifications, to create what is known as a substitute check, which is the legal equivalent of the original paper check. Check 21 has thus opened the door for remote check deposit solutions wherein electronic check images, rather than original paper checks, are used to make deposits, thereby enabling businesses to eliminate trips to the bank. In addition, the use of check images also reduces check transportation costs among banks and improves funds availability.

In current remote check deposit implementations, when the depositor wishes to make a deposit, an operator, such an accounts receivable clerk, creates an electronic image of each of the checks to be deposited using a scanner. As the checks are scanned, the operator enters the dollar amount of each check, referred to herein as the intended amount, into either the scanner or a personal computer (PC) coupled to the scanner. Once the images are created and the intended amount of each check is obtained, that information is transmitted through a secure network connection, such as through the Internet, to the depository bank and is used to make the appropriate deposits to the depositor's account.

As will be appreciated, such remote check deposit systems add convenience for depositors and reduce the amount of, and thus the cost of, bank operator intervention. However, current remote check deposit solutions also present a number of problems. For example, due to a number of factors, such as a large number of checks being processed, poor lighting, difficult to read handwriting, or boredom, mistakes are often made during the data entry process resulting in the intended amount not matching the legal and/or courtesy amount of a check. These mistakes can cause difficulties during the downstream processing of the checks and delay the payment thereof. Similarly, a depositor may attempt to commit fraud by purposefully entering an intended amount that is greater than the legal and/or courtesy amount of a check. Thus, there is a need for a check processing system that links and indication of the intent of the depositor when entering an intended amount with the image of the check in question so that mistakes can be caught and easily remedied and so that fraud can be detected and prevented.

### SUMMARY OF THE INVENTION

Provided is a method of processing a check prior to submitting the check for deposit in which the intent of the depositor at the time of submitting the check is linked with an image of the check. The method includes receiving intended amount information for the check, which is an amount of the check that is indicated by the depositor of the check, generating a first image of a front of the check, and generating an image of the intended amount. The method further includes generating a second image of the front of the check using the first image of the front of the check, wherein the second image of the front of the check includes the image of the intended amount and wherein the first image of the front of the check may be obtained from the second image of the front of the check. Finally, the method includes submitting at least the second image of the front of the check to a depository bank.

The method may further include generating a first image of a back of the check and generating a second image of the back of the check using the first image of the back of the check, wherein the first image of the back of the check may be obtained from the second image of the back of the check. In this case, the second image of the back of the check includes an image of a signature endorsement of the depositor, and the submitting step also includes submitting the second image of the back of the check to the depository bank.

Preferably, the submitting step includes creating a signed intent data package for the check that includes an intent data package and a digital signature of the intent data package. The intent data package includes at least a set of first data including the second image of the front of the check. The first data may further include one or more of an account number of an account into which the check is to be deposited, a name on the account, the intended amount, an account and routing number for the check, and a check number of the check. The first data may also include, where appropriate, the second image the back of the check.

In addition, the submitting step may further include creating a signed deposit data package that includes a deposit data package and a digital signature of the deposit data package, wherein the deposit data package includes the signed intent data package for the check being submitted for deposit described above and one or more additional signed intent data packages. Each of the additional signed intent data packages corresponds to one of one or more additional checks being submitted for deposit. The deposit data package may also further include one or more of an account number of an account into which the check and the one or more additional checks are to be deposited, a name on the account, a total deposit amount, and a count of the total number of signed intent data packages being included.

In an alternate embodiment, the method may further include printing the intended amount on the front of the check after the step of generating the first image of the front of the check. This method may also further include steps of generating a first image of a back of the check, generating a transaction number for the check and printing the transaction number on the back of the check after the step of generating the first image of the back of the check, and generating a second image of the back of the check using the first image of the back of the check, wherein the second image of the back of the check includes an image of the transaction number, and wherein the first image of the back of the check may be obtained from the second image of the back of the check. In this case, the submitting step also includes submitting the second image of the back of the check to the depository bank. Also, the second image of the back of the check may further include an image of a signature endorsement of the depositor.

In yet another embodiment, the method may further include steps of obtaining MICR line information from the check, determining whether the MICR line information includes MICR amount information, printing the intended amount on the front of the check after the step of generating the first image of the front of the check if it is determined that the MICR line information does not include the MICR amount information, determining whether the MICR line amount information is equal to the intended amount if it is determined that the MICR line information includes the MICR amount information, and indicating an error if it is determined that the MICR line amount information is not equal to the intended amount.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of check processing system for implementing a method of processing checks according to the present invention;

FIG. 2 is a flowchart illustrating a first embodiment of a method of processing checks according to the present invention;

FIG. 3 is a flowchart illustrating a second embodiment of a method of processing checks according to the present invention.

### DESCRIPTION OF THE PREFERRED EMBODIMENTS

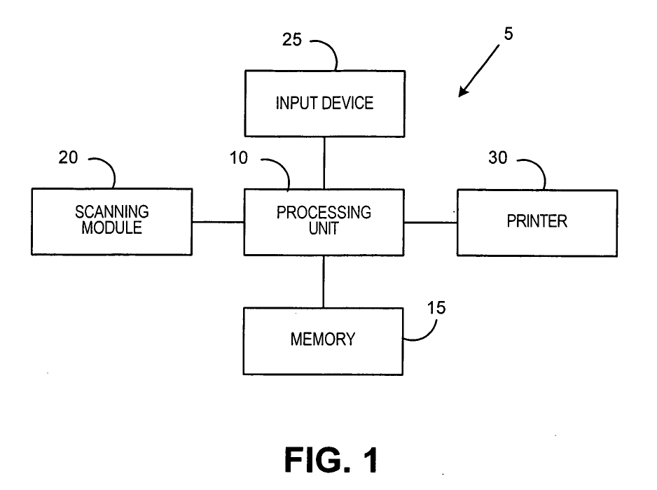

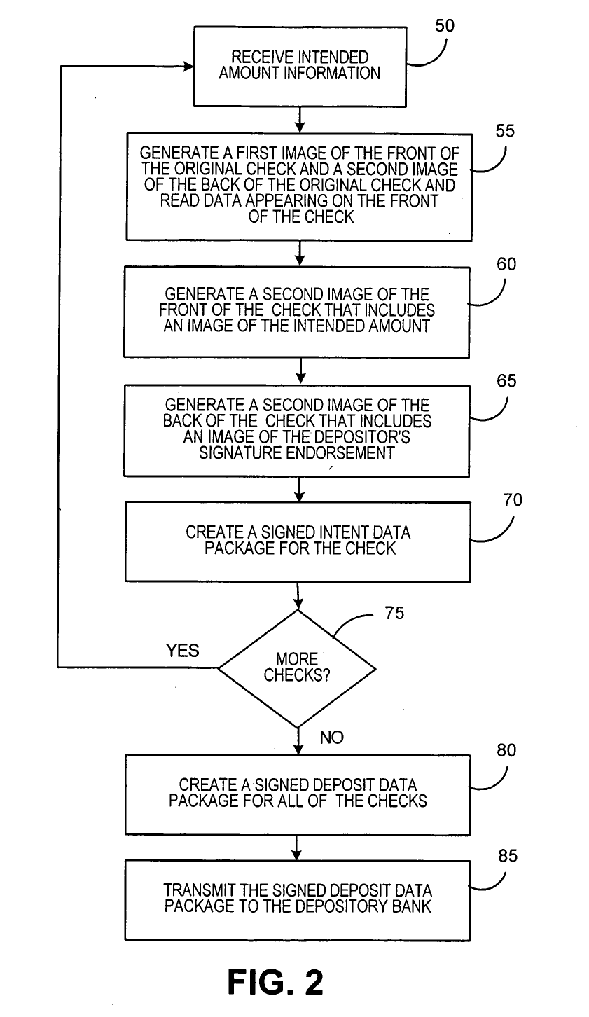

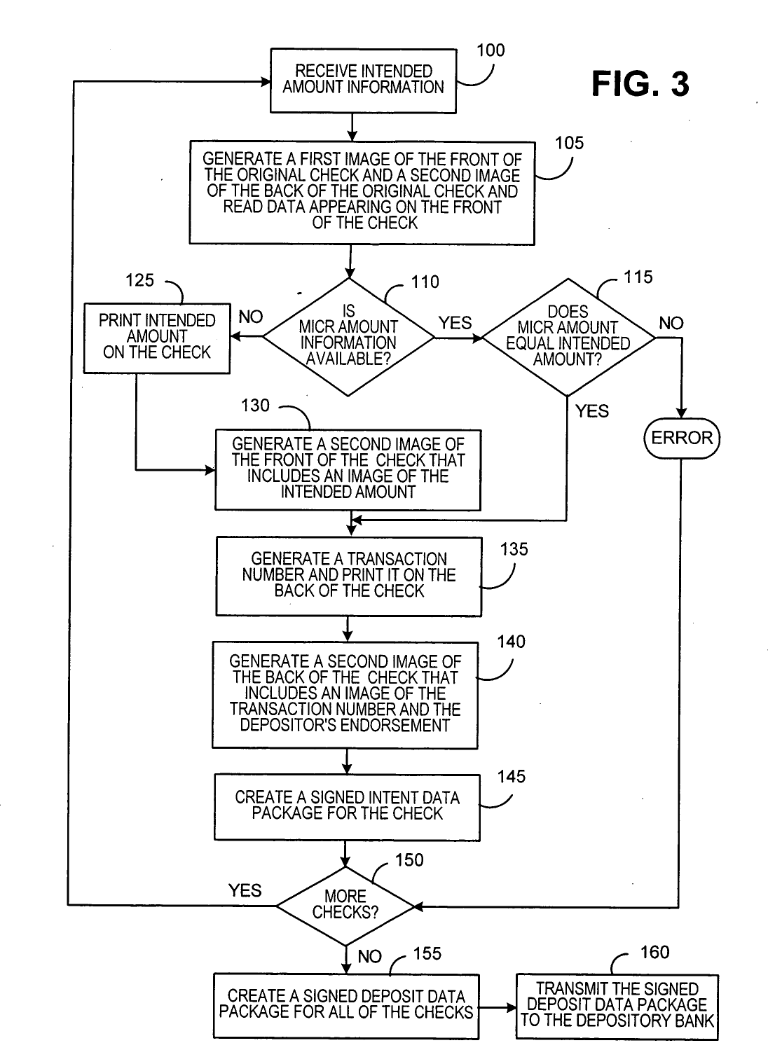

FIG. 1 is a block diagram of a check processing system 5 for implementing a method of processing checks according to the present invention. Check processing system 5 enables a depositor to remotely deposit a number of checks in a particular depository bank. Check processing system 5 includes a processing unit 10, such as a microprocessor, and a memory 15 coupled thereto. The memory 15 may be any of a variety of types of internal and/or external storage media such as, without limitation, RAM, ROM, EPROM(s), EEPROM(s), and the like that provide a storage register for data storage such as in the fashion of an internal storage area of a computer, and can be volatile memory or nonvolatile memory. The memory 15 stores routines that are executable by the processing unit 10 and that implement the functionality of the present invention as described in connection with FIGS. 2 and 3 below. Check processing system 5 also includes a digital scanning module 20 that is in electronic communication with the processing unit 10 for scanning and thereby creating electronic images of the checks to be deposited. An input device 25 is also in electronic communication with the processing unit 10 for enabling an operator to input information such as the intended amount for each check being processed. The input device 25 may be, for example, a keypad, a keyboard, a touch screen or the like. A printer 30, such as an inkjet print head and associated controller, is in electronic communication with the processing unit 10 for enabling information to be printed onto the check being processed as described herein. Finally, the check processing system 5 is in electronic communication with a network (not shown), which may be, for example, the Internet, one or more private computer networks, or any combination thereof so that information relating to the checks being deposited may be transmitted to a depository bank computer (not shown), which is a computer designated by the depository bank to receive and process electronic deposit information.

FIG. 2 is a flowchart that shows a first embodiment of a method of processing checks using the check processing system 5 according to the present invention in which information relating to the intent of the depositor is linked with an image of the corresponding check. The method begins at step 50, wherein the intended amount of the first check being processed is received by the processing unit 10. As will be appreciated, the intended amount is input by an operator using the input device 25, and may be done after the check has been transported, automatically, from a loading position in which all of the checks to be processed are stacked to a viewing position in which the check can be readily and conveniently viewed. Next, at step 55, two images of the check are created using the scanning module 20, namely a first image of the front of the check and a first image of the back of the check. In addition, certain information is read from the front of the check using OCR techniques. Such information may include the legal amount of the check, the courtesy amount of the check, and the MICR (Magnetic Ink Character Recognition) line information of the check. As is known, the MICR line is created using a special font and using magnetic ink. Thus, in the case of the MICR line information, it may be read using conventional OCR techniques or, alternatively, by using a magnetic read head to read the magnetic ink.

At step 60, a second image of the front of the check is generated that includes an image of the intended amount that was entered during step 50. The image of the intended amount may be located at or near the MICR line amount position (lower right) of the check. Preferably, the second image of the front of the check is generated in manner that allows the first image of the front of the check (the original check) to be recovered therefrom. This is important because the first image of the front of the check can be used for forensic purposes as the “best” copy of the front of the check. For example, the second image may be generated using an image format, such as pdf or psd, which allows images to be created in layers. In such a case, the first image of the front of the check is a first layer, the image of the intended amount that is generated is a second layer, and the second image of the front of the check is an image consisting of the first and second layers combined. Other known methods of creating the second image of the front of the check using a reversible set of instructions, such as using the file structure of the image itself (e.g., the Bitmap BMP file format), may also be used.

Next, at step 65, a second image of the back of the check is generated that includes an image of the depositor's signature endorsement that is stored in the memory 15. This is possible because one aspect of Check 21 is that is allows check cashers to endorse an electronic image of a check as opposed to the physical check itself. Prior to Check 21, the physical check itself had to be endorsed, such as by using an endorsement stamp. As was the case with the second image of the front of the check, the second image of the back of the check is generated in manner that allows the first image of the back of the check (the original check) to be recovered therefrom. Again, this will allow the first image of the back of the check to be used as a “best” forensic copy if necessary. Any of the methods described above may be used to create the second image of the back of the check that allows recovery of the first image of the back of the check.

At step 70, a signed intent data package is created for the check as follows. First, an intent data package is created by assembling certain information including the second image of the front of the check and, preferably, the second image of the back of the check. In the preferred embodiment, the intent data package includes (1) the account number of the account into which the check is to be deposited; (2) the name on the account into which the check is to be deposited; (3) the intended amount for the check; (4) the account and routing number for the check; (5) the check number of the check; (6) the second image of the front of the check; and (7) the second image of the back of the check. Alternatively, various combinations of this or other data may also be used to create the intent data package. Second, a digital signature of the intent data package is generated, preferably using a private key of the depositor (which is part of a private/public key pair). Third, the signed intent data package is created by combining the intent data package and the digital signature, such as by appending the latter to the former. As will be appreciated, the signed intent data package provides two beneficial features. One, it captures the depositor's intent when depositing the check by including the intended amount in the second image of the front of the check and, possibly, as a separate data element. Two, by virtue of the digital signature, it provides cryptographic data integrity and non-repudiation at the moment of imaging and intent declaration.

Next, at step 75, a determination is made as to whether there are any more checks that need to be processed. If the answer is yes, then the method returns to step 50 to repeat the above-described processing for the next check forming a part of the deposit. If the answer is no at step 75, then the method proceeds to step 80. At step 80, a signed deposit data package is created for all of the checks to be deposited (and that have been processed) as follows. First, a deposit data package is created that includes at least the signed intent data package created for each of the checks that have been processed as part of the deposit. In the preferred embodiment, the deposit data package includes (1) the account number of the account into which the checks are to be deposited; (2) the name on the account into which the checks are to be deposited; (3) the total amount that the depositor is claiming to deposit; (4) the number of signed intent data packages that are included; and (5) a list including the signed intent data package of each of the checks forming a part of the deposit. Alternatively, various combinations of this data or other data may also be used to create the deposit data package. Second, a digital signature of the deposit data package is generated, preferably using a private key of the depositor (which is part of a private/public key pair). Third, the signed deposit data package is created by combining the deposit data package and the digital signature, such as by appending the latter to the former. Finally, at step 85, the signed deposit data package is transmitted to the depository bank for processing thereby.

In an alternative embodiment of the method shown in FIG. 2, step 65 may be omitted for one or more of the checks, in which case the check will need to have been physically endorsed, preferably before the method of FIG. 2 is initiated. When this occurs, the first image of the back of the check will be used whenever the method calls for the second image of the back of the check.

FIG. 3 is a flowchart that shows a second embodiment of a method of processing checks using the check processing system 5 according to the present invention in which information relating to the intent of the depositor is linked with an image of the corresponding check. The method begins at step 100, wherein the intended amount of the first check being processed is received by the processing unit 10 in the manner described in connection with FIG. 2. Next, at step 105, two images of the check are created using the scanning module 20, namely a first image of the front of the check and a first image of the back of the check. In addition, certain information is read from the front of the check using OCR techniques. Such information may include the legal amount of the check, the courtesy amount of the check, and the MICR line information of the check. As described above, in the case of the MICR line information, it may be read using OCR or, alternatively, by using a magnetic read head to read the magnetic ink.

Next, at step 110, a determination is made as to whether the MICR line information that was read includes the amount of the check as one of the data fields. As is known, the MICR line amount may be added to a check by, for example, a check originator or by a depositor prior to making a deposit (in which case the depositor often receives a discount on fees). If the answer at step 110 is yes, then, at step 115, a determination is made as to whether the intended amount that was received is equal to the MICR line amount. If the answer is no, then at step 120, an error condition is detected and indicated to the operator, the check is diverted out of the processing stream, preferably to an error bin or the like, and the images of it are deleted. The method then proceeds to step 150 described below. If the answer is yes at step 115, then the method proceeds to step 135 described below. If, however, the answer at step 110 is no, then, at step 125, the intended amount is printed on the check, preferably at the MICR amount location in the MICR line, by the printer 30.

At step 130, a second image of the front of the check is generated that includes an image of the intended amount that was entered during step 100. Preferably, as discussed in more detail in connection with FIG. 2, the second image of the front of the check is generated in manner that allows the first image of the front of the check (the original check) to be recovered therefrom. This is important because the first image of the front of the check can be used for forensic purposes as the “best” copy of the front of the check.

At step 135, a transaction number, preferably sequential in nature, is generated for the check and is printed on the back of the check using the printer 30. The purpose of the transaction number is to uniquely identify the check so that it can be later referenced, such as by the depository bank, and easily found by the depositor. Next, at step 140, a second image of the back of the check is generated that includes an image of the transaction number of the check and, preferably, the depositor's signature endorsement that is stored in the memory 15. As was the case with the second image of the front of the check, the second image of the back of the check is generated in manner that allows the first image of the back of the check (the original check) to be recovered therefrom. Again, this will allow the first image of the back of the check to be used as a “best” forensic copy if necessary. Any of the methods described above may be used to create the second image of the back of the check that allows recovery of the first image of the back of the check.

At step 145, a signed intent data package is created for the check as follows. First, an intent data package is created by assembling certain information including the second image of the front of the check, if generated, and the second image of the back of the check. If the second image of the front of a check is not generated, then the intent data package for that check will include the first image of the front of the check. In the preferred embodiment, the intent data package includes (1) the account number of the account into which the check is to be deposited; (2) the name on the account into which the check is to be deposited; (3) the intended amount for the check; (4) the account and routing number for the check; (5) the check number of the check; (6) the second image of the front of the check if no MICR amount is available and the first image of the front of the check if the MICR amount is available and equals the intended amount; and (7) the second image of the back of the check. Alternatively, various combinations of this or other data may also be used to create the intent data package. Second, a digital signature of the intent data package is generated, preferably using a private key of the depositor (which is part of a private/public key pair). Third, the signed intent data package is created by combining the intent data package and the digital signature, such as by appending the latter to the former. As was the case with the method of FIG. 2, the signed intent data package provides two beneficial features. One, it captures the depositor's intent when depositing the check by including the intended amount in the second image of the front of the check (for those checks that do not include an MICR amount) and, possibly, as a separate data element. Two, by virtue of the digital signature, it provides cryptographic data integrity and non-repudiation at the moment of imaging and intent declaration.

Next, at step 150, a determination is made as to whether there are any more checks that need to be processed. If the answer is yes, then the method returns to step 100 to repeat the above-described processing for the next check forming a part of the deposit. If the answer is no at step 150, then the method proceeds to step 185. At step 185, a signed deposit data package is created for all of the checks to be deposited in the manner described in connection with step 80 of FIG. 2. Finally, at step 160, the signed deposit data package is transmitted to the depository bank for processing thereby.

In an alternative embodiment of the method shown in FIG. 3, the image created in step 140 may omit the depositor's signature endorsement for one or more of the checks, in which case the check will need to have been physically endorsed, preferably before the method of FIG. 3 is initiated. In a further alternative embodiment, steps 135 and 140 may be omitted altogether. When this occurs, the first image of the back of the check will be used whenever the method calls for the second image of the back of the check.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of processing a check prior to submitting the check for deposit, comprising:
receiving intended amount information for said check, said intended amount information being an amount of said check that is indicated by a depositor of said check;
generating a first image of a front of said check;
generating an image of said intended amount;
generating a second image of said front of said check using said first image of said front of said check, said second image of said front of said check including said image of said intended amount, wherein said first image of said front of said check may be obtained from said second image of said front of said check; and
submitting said second image of said front of said check to a depository bank.

2. The method according to claim 1, further comprising:
generating a first image of a back of said check; and
generating a second image of said back of said check using said first image of said back of said check, said second image of said back of said check including an image of a signature endorsement of the depositor, wherein said first image of said back of said check may be obtained from said second image of said back of said check;
wherein said submitting step also includes submitting said second image of said back of said check to the depository bank.

3. The method according to claim 1, wherein said submitting step comprises creating a signed intent data package for said check, said singed intent data package including an intent data package and a digital signature of said intent data package, said intent data package including first data including said second image of said front of said check.

4. The method according to claim 3, wherein said first data further includes one or more of an account number of an account into which said check is to be deposited, a name on said account, said intended amount, an account and routing number for said check, and a check number of said check.

5. The method according to claim 2, wherein said submitting step comprises creating a signed intent data package for said check, said singed intent data package including an intent data package and a digital signature of said intent data package, said intent data package including first data including said second image of said front of said check and said second image of said back of said check.

6. The method according to claim 5, wherein said first data further includes one or more of an account number of an account into which said check is to be deposited, a name on said account, said intended amount, an account and routing number for said check, and a check number of said check.

7. The method according to claim 3, wherein said digital signature is generated using a private key of said depositor.

8. The method according to claim 5, wherein said digital signature is generated using a private key of said depositor.

9. The method according to claim 3, wherein said submitting step further comprises creating a signed deposit data package, said singed deposit data package including a deposit data package and a digital signature of said deposit data package, said deposit data package including said signed intent data package and one or more additional signed intent data packages, each of said additional signed intent data packages corresponding to one of one or more additional checks being submitted for deposit.

10. The method according to claim 9, wherein said deposit data package further includes one or more of an account number of an account into which said check and said one or more additional checks are to be deposited, a name on said account, a total deposit amount, and a count of said signed intent data package and said one or more additional signed intent data packages.

11. The method according to claim 1, further comprising printing said intended amount on said front of said check after said step of generating said first image of said front of said check.

12. The method according to claim 11, further comprising:
generating a first image of a back of said check;
generating a transaction number for said check and printing said transaction number on said back of said check after said step of generating said first image of said back of said check; and
generating a second image of said back of said check using said first image of said back of said check, said second image of said back of said check including an image of said transaction number, wherein said first image of said back of said check may be obtained from said second image of said back of said check;
wherein said submitting step also includes submitting said second image of said back of said check to the depository bank.

13. The method according to claim 12, wherein said second image of said back of said check further includes an image of a signature endorsement of the depositor.

14. The method according to claim 12, wherein said submitting step comprises creating a signed intent data package for said check, said singed intent data package including an intent data package and a digital signature of said intent data package, said intent data package including first data including said second image of said front of said check and said second image of said back of said check.

15. The method according to claim 14, wherein said submitting step further comprises creating a signed deposit data package, said singed deposit data package including a deposit data package and a digital signature of said deposit data package, said deposit data package including said signed intent data package and one or more additional signed intent data packages, each of said additional signed intent data packages corresponding to one of one or more additional checks being submitted for deposit.

16. The method according to claim 1, further comprising:
obtaining MICR line information from said check;
determining whether said MICR line information includes MICR amount information;
printing said intended amount on said front of said check after said step of generating said first image of said front of said check if it is determined that said MICR line information does not include said MICR amount information;
determining whether said MICR line amount information is equal to said intended amount if it is determined that said MICR line information includes said MICR amount information; and
indicating an error if it is determined that said MICR line amount information is not equal to said intended amount.

17. The method claimed in claim 1, wherein said second image is encoded in a mica line on said second image on the front of the check.
